(19) United States
(12) Patent Application Publication
(10) Pub. No.: US 2002/0088852 A1
(43) Pub. Date: Jul. 11, 2002

(54) Card issuing agent system

(75) Inventors: Akimasa Ohta, Tokyo (JP); Hisaharu Sakamoto, Tokyo (JP)

Correspondence Address: SUGHRUE, MION, ZINN,, MACPEAK & SEAS, 2100 Pennsylvania Avenue, N.W., Washington, DC, 20037-3202, US

(73) Assignee: NEC CORPORATION

(21) Appl. No.: 10/026,702

(22) Filed: Dec. 27, 2001

(30) Foreign Application Priority Data
Jan. 9, 2001 (JP) 2001-001457

(51) Int. Cl. G06F 7/08

(52) U.S. Cl. 235/381

(57) ABSTRACT

A card issuing agent system of the present invention includes: an information terminal for transmitting a card issuance application of a user connected to a communication network and his personal information to be examined and also receiving an examination result; a server for receiving the card issuance application and the personal information to then examine them for decision of card issuance permission/refusal and create/store an ID and a password necessary for card issuance and then transmit the examination result to the information terminal which applied for card issuance; and a card issuing machine installed in an around-the-clock store, for receiving an application for card issuance to then collate the ID and the password.

### BACKGROUND OF THE INVENTION

1. Field of the Invention

The present invention relates to a card issuing system and, more particularly to, a card issuing agent system.

2. Description of the Related Art

In conventional card issuing system, a user is supposed to go to an office where a card issuing machine is installed, thus making an application for card issuance.

This method, however, takes a long time to examine the application for card issuance, so that the user must wait at or near the office. Also, although an unmanned office is open for 24 hours a day, card issuance application cannot be made beforehand and so takes a long time for its examination, during which the user must be waiting.

### SUMMARY OF THE INVENTION

It is an object of the present invention to propose a card issuing agent system by which a user makes an application for issuing of a card at an information terminal beforehand while a server at a personal finance company examines the card issuance application to then record information necessary for card issuance in a card issuing machine installed in an around-the-clock store so that a card can be issued immediately upon requisition by the user.

It is another object of the present invention to propose a card issuing agent system by which a personal finance company can conduct examination involved in card issuance immediately upon application of a user, to thereby easily transmit an examination result to his information terminal even the user is in far from the personal finance company.

In order to achieve above mentioned object, a card issuing agent system comprising: an information terminal through which information of application for issuance of a card of a user and personal information of said user to be examined are transmitted and also through which an examination result is received; a server for receiving said card issuance application information and said personal information to examine said application for decision of permission/refusal thereof and then store in database an examination result as well as an ID and a password necessary for issuance of a card in the case of permission in examination and transmit said examination result to said information terminal; a card issuing machine for receiving card issuance requisition information to then collate an ID and a password thus received upon card issuance requisition with said ID and said password transmitted from said database of said server for card issuance; and a communication network for interconnecting said information terminal, said server, and said card issuing machine.

Moreover, a card issuing agent system according present invention, wherein when said information terminal received the examination result, said information terminal receives notification of card issuance permission and necessary ID and password if said application passed said examination and, otherwise, receives notification of card issuance refusal.

Moreover, a card issuing agent system according to present invention, wherein when transmitting an examination result, said server creates the ID and the password and transmits to said information terminal said ID and said password as well as notification of card issuance permission and also transmits to said card issuing machine such card issuance information as a card number and a name of said user necessary for card issuance if said card issuance application passed said examination and, otherwise, transmits notification of card issuance refusal to said information terminal.

Moreover, a card issuing agent system according to present invention, wherein when issuing a card, said card issuing machine receives a card issuing requisition to then record information in magnetic stripes on a card based on such card issuance information as said card number and said user's name; and collates entered ID and password with recorded ones and, only when they agree, issues a corresponding card.

Moreover, a card issuing agent system according to present invention, wherein the card having the magnetic stripe provided with an IC chip thereon.

Moreover, a card issuing agent system according to present invention, wherein said communication network for giving communication services is the Internet; and said server is a web server.

Moreover a card issuing agent system according to present invention, wherein said information terminal is a mobile telephone, a portable information terminal, or a personal computer.

Moreover, a card issuing agent system according to present invention, wherein said server is installed in a personal finance company.

Moreover, a card issuing agent system according to present invention, wherein said card issuing machine is installed in such a stores as an around-the-clock convenience store.

Moreover, a server used in a card issuing agent system, comprising the functions of: receiving card issuance application information and personal information of a user to be examined from a predetermined information terminal and also transmitting notification of an examination result to said information terminal; examining card issuance application for decision of permission/refusal thereof based on said card issuance application information and said personal information transmitted from a card issuing machine and then storing in a database an examination result and as well as an ID and a password necessary for card issuance after said application passed said examination; and in response to said card issuance application information transmitted from a card issuing machine, transmitting to said card issuing machine said ID and said password stored in said database of said server.

Moreover, a computer program product recorded in a computer-readable recording medium used in a card issuing agent system, executing the following processes of: receiving card issuance application information and personal information transmitted from a predetermined information terminal; storing in a database an examination result as well as an ID and a password necessary for card issuance after an examination came up with permission of card issuance; transmitting said examination result to said information terminal; and in response to a card issuance requisition entered to a card issuing machine, transmitting said ID and said password stored in said database of a server to said card issuing machine.

By the invention, a user can utilize an information terminal to make a reservation for card issuance and then receive an examination result therethrough, so that when his application for card issuance passed examination, the user can receive a card at his convenience which is issued from a card issuing machine, which is installed in a station or around the clock store.

In FIG. 1, the user can transmit a card issuance application information and personal information to be examined to the server of the personal finance company using mobile telephone, portable information terminal personal computer (information terminal). Also, the user terminal receives the examination result of passing, and receives the ID and password required for card issuance. Then the user can input the card issuance information to card issuing machine installed in the station or around the clock store, thus user can get the card.

The server of the personal finance company receives the card issuance application information of the user and examines based on the personal information items to be examined. The server transmits the ID and password to the information terminal of the user if the examination is passed. At same time, the server transmits the card issuance information to the card issuing machine installed in the station or the around the clock store.

The card issuing machine receives the card issuance information transmitted from the server of the personal finance company, records the necessary information on the magnetic stripe of the card. Then the card issuing machine issues the card according to the card issuance requisition entered by the user.

Accordingly, in present invention, a user can utilize an information terminal to make a reservation for card issuance and then receive an examination result therethrough, so that when his application for card issuance passed examination, the user can receive a card at his convenience which is issued from a card issuing machine, which is installed in a station or around the clock store.

### BRIEF DESCRIPTION OF THE DRAWINGS

FIG. 1 is an illustration for showing a configuration of a card issuing agent system according to one embodiment of the present invention;

FIG. 2 is a flowchart for showing operations of the embodiment;

FIG. 3 is a sequence flow chart for showing operations of a user's information terminal, a personal finance company's server, and a card issuing machine; and

FIG. 4 is a block diagram for showing a configuration of the server.

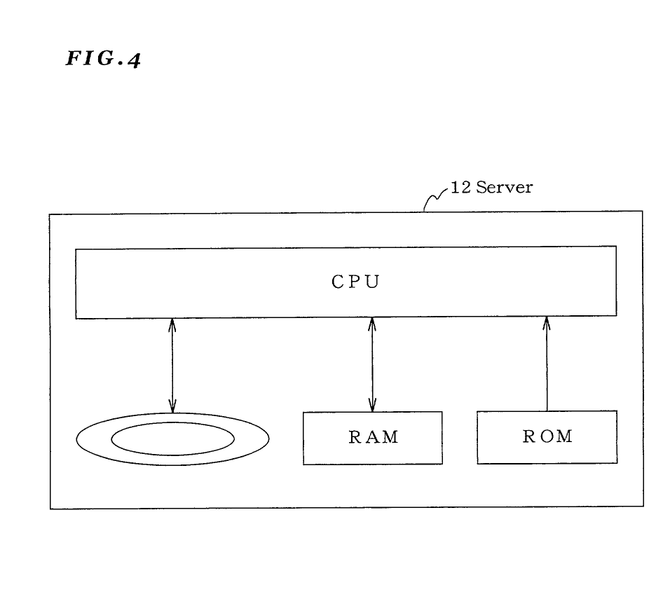

### DESCRIPTION OF THE PREFERRED EMBODIMENTS

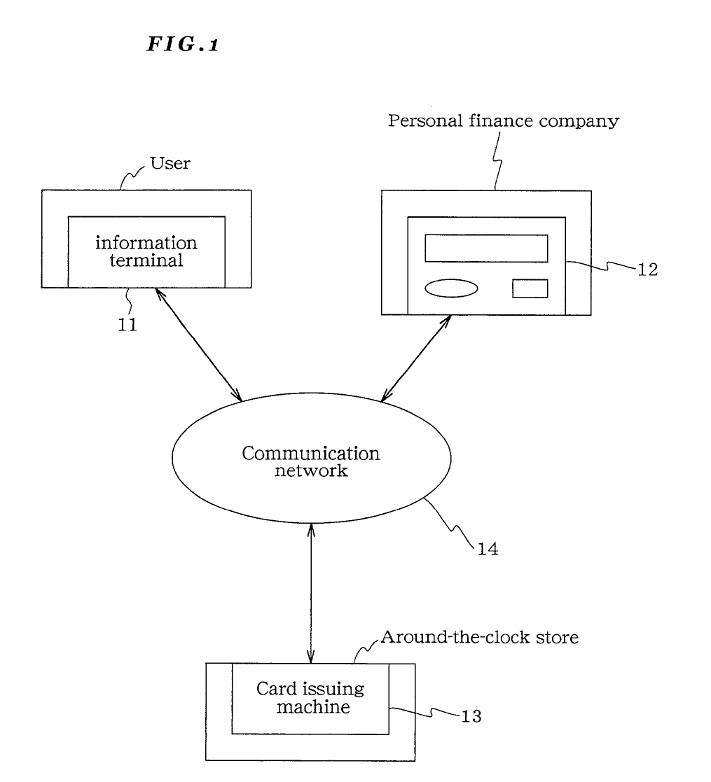

The following will describe one embodiment of the invention with reference to the drawings. FIG. 1 is an illustration for showing a configuration of a card issuing agent system according to one embodiment of the present invention;

As shown in FIG. 1, a card issuing agent system according to the embodiment comprises a user's information terminal 11, a server 12, a card issuing machine 13, and a communication network 14. The card issuing machine 13 is installed in an around-the-clock store such as a convenience store for issuing a card in place of a personal finance company. The card issuing machine vicariously issues the card to be issued by the personal finance company.

The card issuing machine 13 has a publicly known configuration, for recording necessary information in a magnetic stripe on a card based on such data as a card number, a user's name, etc. transmitted from the personal finance company and, upon entry of an ID and a password by the user, collating them with his ID and password recorded in a database of the server 12 at the personal finance company and then, if they agree, issuing a card.

The server 12 is installed in the personal finance company. The server 12 stores therein the card issuance application information and examination-subject items transmitted from the user's information terminal 11 to thereby examine these items. When the examination comes up with permission, the server 12 transmits such examination result of passing to the user's information terminal 11 that indicates his application passed the examination. The server 12 transmits also card issuance information such as the card number, the user's name, etc. to the card issuing machine 13 installed in the around-the-clock store.

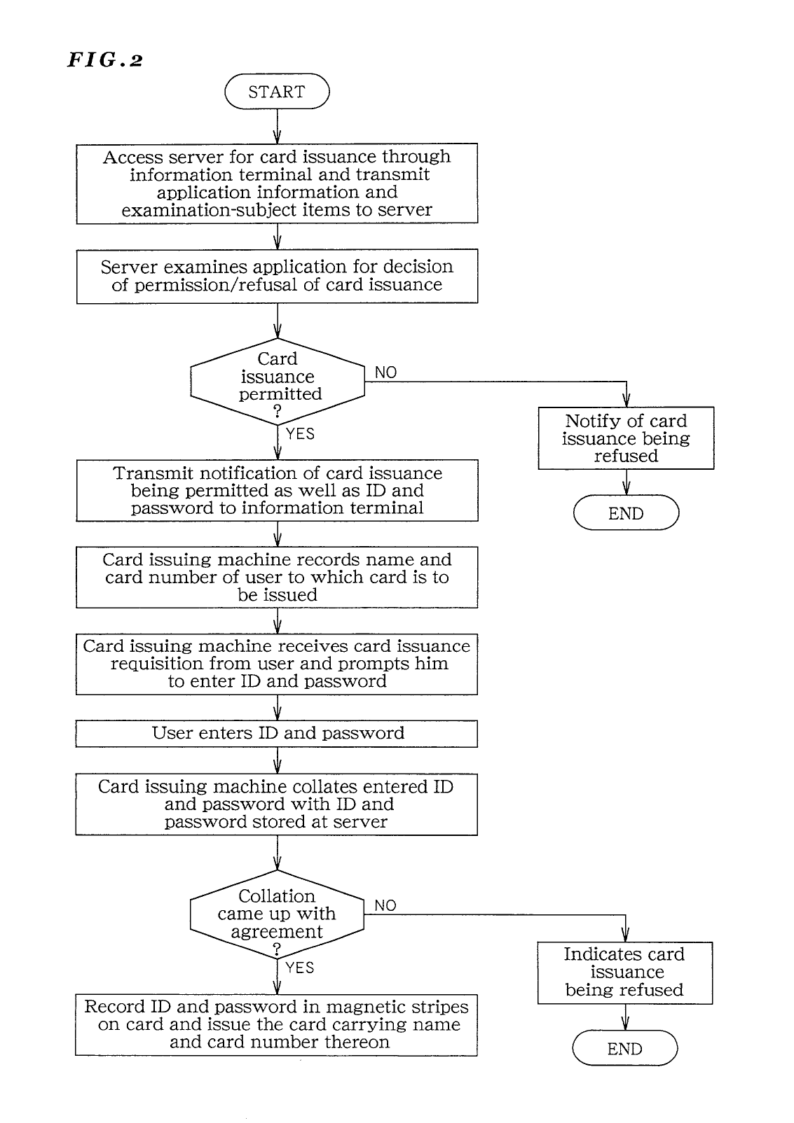

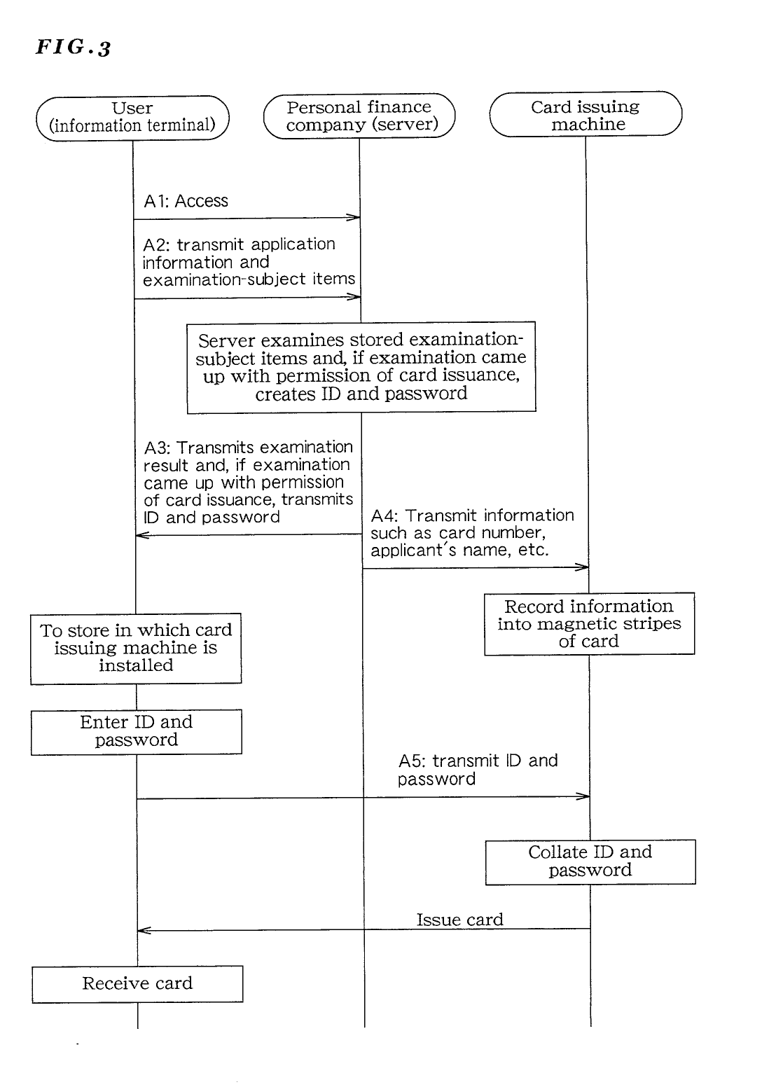

Next, the operations of this embodiment are described with reference to the drawings. Here, FIG. 2 is a flowchart for showing operations of the embodiment and FIG. 3 is a sequence flow chart for showing operations of a user's information terminal, a personal finance company's server, and a card issuing machine

As shown in FIG. 2, the user uses the information terminal 11 to access the server 12 managed by the personal finance company in order to apply for issuance of a card and then transmits application information and examination-subject items to the server 12 (Sl). After receiving the application information and the examination-subject items, the server 12 decides permission/refusal of the application by examination (S2). When the examination comes up with permission (S3) the server 12 transmits to the information terminal 11 an ID and a password necessary for card issuance together with the information indicating the permission of card issuance (S4). If the examination comes up with refusal, on the other hand, the server 12 transmits the notification of refusal of card issuance to the information terminal 11 (S5).

The server 12 transmits the ID and the password to the information terminal 11 and also transmits a name of a person to which a card is to be issued and a card number to the card issuing machine 13, which in turn records the name of the person to which the card is to be issued and the card number (S6). The nearest card issuing machine 13, when having received a requisition from the user for card issuance at his convenience, prompts him to enter his ID and password (S7). The user then enters an ID and a password received with the examination result to the card issuing machine 13 (S8).

The card issuing machine 13 collates thus entered ID and password with an ID and a password recorded in the database of the server 12 (S9) When the collation comes up with agreement (S10), the card issuing machine 13 records the ID and the password in a magnetic stripe on a card and issues a card which carries thereon the corresponding name and card number (S11). If the collation comes up with disagreement, it indicates the refusal of card issuance (S12).

As shown in FIG. 3, the user uses the information terminal 11 to access a homepage (Web server) of the server 12 managed by the personal finance company (A1). The user's information terminal 11 transmits to the server 12 the application information and the examination-subject items in order to apply for card issuance (A2).

The personal finance company's server 12 stores in a recording medium of the server 12 the application information and the examination-subject items transmitted from the user's information terminal 11 and then examines them based on thus stored examination-subject items in order to decide permission/refusal of card issuance. If card issuance is refused, the personal finance company's server 12 transmits the refusal of card issuance to the user's information terminal 11 and notifies the user of it.

When card issuance of permitted, on the other hand, the personal finance company's server 12 creates an ID and a password and transmits them as well as the notification of permission of card issuance to the user's information terminal 11 (A3). It also transmits to the card issuing machine 13 installed in the around-the-clock store such information including a card number a name of a relevant person that is necessary for card issuance (A4).

The card issuing machine 13 records in magnetic stripes on the card the variety kinds of information transmitted from the server 12 of the personal finance company.

Upon reception of the notification of card issuance being possible, the user's information terminal 11 receives the notification of card issuance permission and also the ID and the password necessary for getting a card from the card issuing machine 13.

The user goes to an around-the-clock store at his convenience and enters through the card issuing machine 13 installed there the ID and the password received from the server 12 of the personal finance company for requesting it to issue a card (A5).

The card issuing machine 13 collates these ID and password entered by the user with these ID and password transmitted from the server 12 and, only when they agree, issues the corresponding card. The user receives the card thus issued there.

Although this embodiment has been described as a card issuing agent system using the card issuing machine 13, the invention of source enables borrowing/payment as far as a card used has a cash withdrawing/depositing function along with a card issuing function. That is, such a configuration may be possible that borrowing application information etc. is transmitted from an information terminal to a server, which in turn examines the application and, if the application passes the examination, transmits an examination result, an ID, a password, etc. to the information terminal.

Also, although this embodiment has exemplified a case where a card with magnetic stripes is issued, it may be a card carrying an IC chip thereon.

The above-mentioned card issuing agent system can be implemented also by a computer program. That is, the server 12 may be provided with, for example, the Central Processing Unit (CPU), a hard disk, and recording media such as a ROM and a RAM. In this configuration, the CPU can read out the program from the hard disk or the ROM to execute necessary processing. In this processing, the necessary information is saved in the RAM temporarily.

Thus, the invention has the following effects.

The first effect is that since a user applies beforehand for issuing of a card through an information terminal so that a personal finance company's server examines the application to record information necessary for issuing the card by a card issuing machine installed in an around-the-clock store, the user can go to an installation place of the card issuing machine to immediately receive the card issued there.

The second effect is that immediately when an application is made for issuing of a card, the personal finance company examines the application and transmits an examination result to a user's information terminal, thus enabling the user to confirm the examination result immediately.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-001457 (Filed on Jan. 9th, 2001) including specification, claims, drawings and summary are incorporated herein by reference in its entirety.

What is claimed is:

1. A card issuing agent system comprising:
an information terminal through which information of application for issuance of a card of a user and personal information of said user to be examined are transmitted and also through which an examination result is received;
a server for receiving said card issuance application information and said personal information to examine said application for decision of permission/refusal thereof and then store in database an examination result as well as an ID and a password necessary for issuance of a card in the case of permission in examination and transmit said examination result to said information terminal;
a card issuing machine for receiving card issuance requisition information to then collate an ID and a password thus received upon card issuance requisition with said ID and said password transmitted from said database of said server for card issuance; and
a communication network for interconnecting said information terminal, said server, and said card issuing machine.

2. The card issuing agent system according to claim 1, wherein when said information terminal received the examination result, said information terminal receives notification of card issuance permission and necessary ID and password if said application passed said examination and, otherwise, receives notification of card issuance refusal.

3. The card issuing agent system according to claim 1, wherein when transmitting an examination result, said server creates the ID and the password and transmits to said information terminal said ID and said password as well as notification of card issuance permission and also transmits to said card issuing machine such card issuance information as a card number and a name of said user necessary for card issuance if said card issuance application passed said examination and, otherwise, transmits notification of card issuance refusal to said information terminal.

4. The card issuing agent system according to claim 1, wherein when issuing a card, said card issuing machine receives a card issuing requisition to then record information in magnetic stripes on a card based on such card issuance information as said card number and said user's name; and collates entered ID and password with recorded ones and, only when they agree, issues a corresponding card.

5. The card issuing agent system according to claim 1, wherein the card having the magnetic stripe provided with an IC chip thereon.

6. The card issuing agent system according to claim 1, wherein said communication network for giving communication services is the Internet; and said server is a web server.

7. The card issuing agent system according to claim 1, wherein said information terminal is a mobile telephone, a portable information terminal, or a personal computer.

8. The card issuing agent system according to claim 1, wherein said server is installed in a personal finance company.

9. The card issuing agent system according to claim 1, wherein said card issuing machine is installed in such a stores as an around-the-clock convenience store.

10. A server used in a card issuing agent system, comprising the functions of:
receiving card issuance application information and personal information of a user to be examined from a predetermined information terminal and also transmitting notification of an examination result to said information terminal;
examining card issuance application for decision of permission/refusal thereof based on said card issuance application information and said personal information transmitted from a card issuing machine and then storing in a database an examination result and as well as an ID and a password necessary for card issuance after said application passed said examination; and
in response to said card issuance application information transmitted from a card issuing machine, transmitting to said card issuing machine said ID and said password stored in said database of said server.

11. A computer program product recorded in a computer-readable recording medium used in a card issuing agent system, executing the following processes of:
receiving card issuance application information and personal information transmitted from a predetermined information terminal;
storing in a database an examination result as well as an ID and a password necessary for card issuance after an examination came up with permission of card issuance;
transmitting said examination result to said information terminal; and
in response to a card issuance requisition entered to a card issuing machine, transmitting said ID and said password stored in said database of a server to said card issuing machine.
